(19) United States
(12) Patent Application Publication
(10) Pub. No.: US 2016/0236250 A1
(43) Pub. Date: Aug. 18, 2016

(54) SEAL ASSEMBLY AND NECK SEAL FOR ROLLING MILL

(71) Applicant: Siemens Insustry, Inc, Alpharetta, GA (US)

(72) Inventors: Eric L. Johanson, Worcester, MA (US); Earl S. Winslow, Jr., Grafton, MA (US); Matthew D. Palfreman, Charlton, MA (US); Thomas C. Wojtkowski, Jr., Shrewsbury, MA (US); Peter N. Osgood, Westborough, MA (US)

(21) Appl. No.: 14/364,329

(22) PCT Filed: Jan. 20, 2014
(86) PCT No.: PCT/US2014/012168

§ 371 Date: Jun. 11, 2014

Related U.S. Application Data
(60) Provisional application No. 61/756,506, filed on Jan. 25, 2013.

(51) Int. Cl. B21B 31/07; F16J 15/3268; F16J 15/3232

(52) U.S. Cl. CPC B21B 31/078; F16J 15/3232; F16J 15/3268

(57) ABSTRACT

A seal assembly for use in an oil film bearing rotatably supporting a roll in a rolling mill. The seal assembly includes a flexible seal mounted on a tapered intermediate section of the roll neck for rotation with the roll and within a fixed circular seal end plate. The seal end plate has a stepped interior defining annular inboard and outboard sealing surfaces, with the outboard sealing surface having a diameter larger than the diameter of the inboard sealing surface. The flexible seal has inboard and outboard flanges projecting radially into contact respectively with the inboard and outboard sealing surfaces of the seal end plate.

### CROSS REFERENCE TO RELATED APPLICATION

This application claims priority from U.S. Provisional Application Ser. No. 61/756,506 filed Jan. 25, 2013, the entire contents and substance of which are herein incorporated by reference.

### BACKGROUND

1. Field of the Invention

Aspects of the present invention relate generally to the use of flexible seals for bearing applications and with the seal assembly employed in a rolling mill using oil film bearing technologies. Aspects of the present invention are concerned in particular with improvements to the seal assembly and neck seal that prevent contamination ingress and oil escape from such bearings.

2. Description of Related Art

With reference to FIG. 1, a known oil film bearing assembly is shown comprising a roll 10 having an end face 12 and a tapered neck section 14 leading to a reduced tapered diameter 16 surrounded by a sleeve 18. The sleeve 18 is fixed to the roll 10 by a key or other device (not shown) for rotation within a bushing 20 contained by and fixed relative to a roll stand chock 22.

A flexible neck seal 24 is mounted on the tapered roll section 14 for rotation therewith. The seal 24 has a circular body and is held in place between the sleeve 18 and the roll taper 14.

Inboard and outboard flanges 26, 28 project radially outwardly from the seal body. As herein employed, the term “inboard” means a component closest to the roll end face 12, and the term “outboard” means a component closest to the bushing 6 and chock 22. A flinger 30 projects angularly toward the chock 22.

The inboard and outboard flanges 26, 28 have oppositely directed lip seals arranged to contact annular inboard and outboard sealing surfaces 32, 34 of a seal end plate 36. The seal end plate is fixed to and cooperates with the chock 22 to create a sump 38. The annular sealing surfaces 32, 34 of the seal end plate 36 are separated by an inwardly projecting circular flange 37 serving as a mechanical dam. A seal inner ring 40 and a coolant guard 42 complete the seal assembly.

In operation the roll 10, neck seal 24, seal inner ring 40, and sleeve 18 rotate together while the bushing 20, chock 22, seal end plate 36, and coolant guard 42 remain static. Oil is supplied between the sleeve 18 and bushing 20. This oil is formed into a thin lubricating film at the bearing load zone before emerging between the sleeve 18 and bushing 20 for collection in the sump 38.

The flinger 30 and outboard flange 28 serve to retain the oil in the bearing, whereas the coolant guard 42, inner seal ring 40, and inboard flange 26 serve to exclude the external contaminates from penetrating to the bearing.

### SUMMARY

Briefly described, aspects of the present invention relate to an improved seal assembly and neck seal. In accordance with exemplary embodiments, and in comparison to the conventional seal and sealing arrangement depicted in FIG. 1, the seal and seal end plate of the present invention have decreased widths, thereby making it possible to either increase the width of the roll barrel, or to employ alternative bearing geometries within the same roll stand in order to improve the roll stand's load capacity.

The decreased widths of the seal and seal end plate is made possible by eliminating the flange 37 of the conventional seal plate in favor of a stepped interior defining inboard and outboard sealing surfaces, with the outboard sealing surface having a diameter larger than the diameter of the inboard sealing surface, and with both sealing surfaces being connected by and annular dam surface. The seal is correspondingly reconfigured to provide an outboard sealing flange having an outer diameter larger than the outer diameter of the inboard sealing flange.

These and other features and advantages of the present invention will now be described in more detail with reference to the accompanying drawings, wherein:

### BRIEF DESCRIPTION OF THE DRAWINGS

FIG. 1 is a partial cross sectional view of a conventional oil film bearing assembly; and

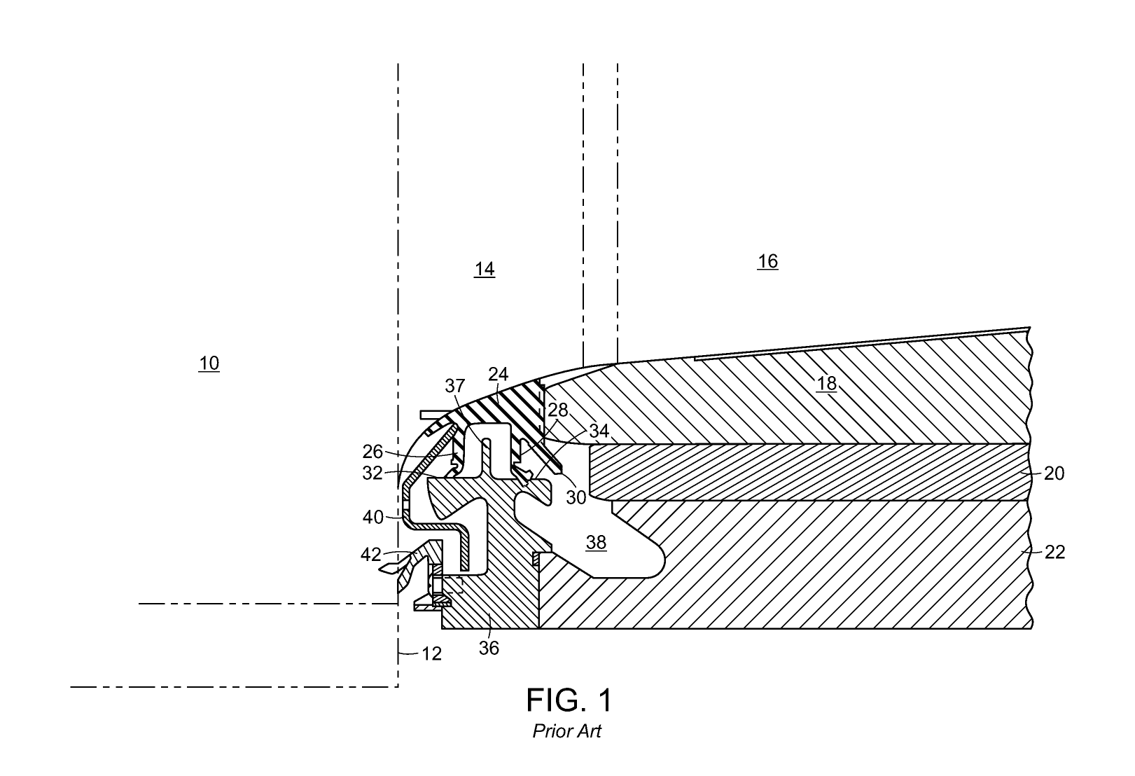

FIG. 2 is a partial cross sectional view of an oil film bearing assembly and seal, in accordance with exemplary embodiments of the present invention.

### DETAILED DESCRIPTION

To facilitate an understanding of the embodiments, principles, and features of the present invention, they are explained hereinafter with reference to the implementation in illustrative embodiments. In particular, they are described in the context of being a seal assembly and neck seal for an oil film bearing in a rolling mill.

The components and materials described hereinafter as making up the various embodiments are intended to be illustrative and not restrictive. Many suitable components and materials that would perform the same or a similar function as the materials and components described herein are intended to be embraced within the scope of embodiments of the present invention.

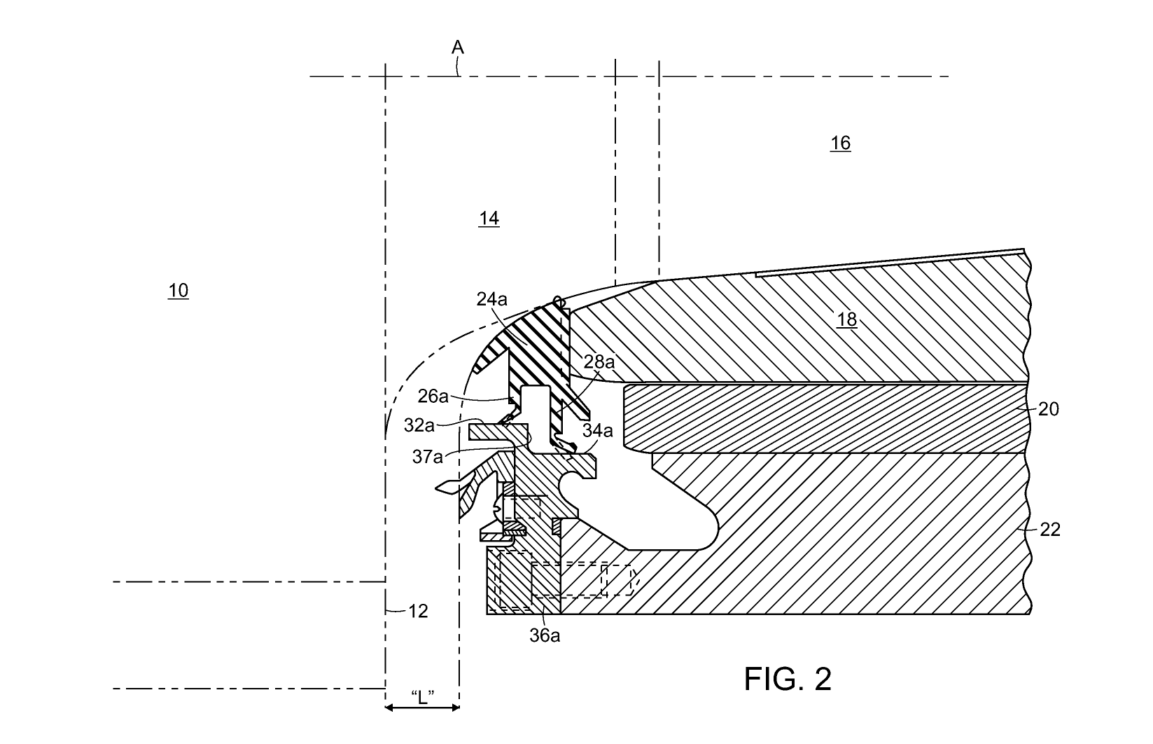

FIG. 2 illustrates an oil film bearing assembly and neck seal in accordance with exemplary embodiments of the present invention. The seal end plate 36a is reconfigured with a stepped interior defining inboard and outboard annular sealing surfaces 32a, 34a, connected by an annular dam surface 37a. The diameter of the outboard sealing surface 34a is larger than the diameter of the inboard sealing surface 32a. Both sealing surfaces 32a, 32b are preferably parallel to the axis “A” of rotation of the roll 10, with the dam surface 37a preferably being perpendicular to the axis A.

The neck seal 24a is correspondingly reconfigured with the outer diameter of the outboard flange 28a being larger than that of the inboard flange 26a.

These reconfigured geometries of the neck seal 24a and seal end plate 36a make it possible to eliminate the flange 37 of the conventional seal end plate 36, which in turn allows the widths of both the neck seal and the seal end plate to be beneficially reduced.

There are many advantages of this arrangement. For example and not limitation, and in no particular order, first, the reduced widths of the neck seal and seal end plate allow for the potential increase in the width of the roll 10 (shown at “L” in FIG. 2) in the same rolling mill stand with its obvious benefits to the mill user. Second, alternatively, the standard roll width can be maintained, with the reduced widths of the seal and seal end plate being utilized for alternate bearing geometries within the same rolling mill stand designed to improve the load capacity of the roll stand. Third, the reconfigured seal assembly simplifies manufacture and assembly of the seal components.

While embodiments of the present invention have been disclosed in exemplary forms, it will be apparent to those skilled in the art that many modifications, additions and deletions can be made therein without departing from the spirit and scope of the invention and its equivalents, as set forth in the following claims.

What is claimed is:

1. A seal assembly for use in an oil film bearing rotatably supporting a roll in a rolling mill, said roll having a neck with an intermediate section tapering from an end face of the roll to a reduced diameter end section contained within a sleeve, the sleeve being fixed in relation to the neck and being journalled for rotation in a bushing contained within a chock, said seal assembly comprising:
a flexible seal mounted on the intermediate section of the roll neck for rotation with the roll and within a circular seal end plate fixed to the chock, said seal end plate having a stepped interior defining annular inboard and outboard sealing surfaces, said outboard sealing surface having a diameter larger than the diameter of said inboard sealing surface, said flexible seal having inboard and outboard flanges projecting radially into contact respectively with said inboard and outboard sealing surfaces.

2. The seal assembly of claim 1 wherein said inboard and outboard sealing surfaces are parallel to the axis of rotation of said roll.

3. The seal assembly of claim 1 wherein said inboard and outboard sealing surfaces are connected by an annular dam surface.

4. The seal assembly of claim 3 wherein said dam surface is perpendicular to the axis of rotation of said roll.

5. A seal assembly for an oil film bearing configured and arranged to rotatably support the neck of a roll in a rolling mill, said seal assembly comprising a fixed circular seal end plate surrounding a flexible seal carried on the roll neck for rotation therewith, said real end plate having a stepped interior defining inboard and outboard sealing surfaces, said outboard sealing surface having a diameter larger than the diameter of said inboard sealing surface, said flexible seal having radially projecting inboard and outboard flanges respectively configured and dimensioned to contact said inboard and outboard surfaces.

6. The seal assembly of claim 5 further comprising a dam surface extending between said inboard and outboard sealing surfaces.

7. The seal assembly of claim 5 wherein said inboard and outboard sealing surfaces are parallel to the axis of rotation of said roll neck, and wherein said dam surface is perpendicular to said axis.

8. A flexible neck seal for use in a tapered neck section of a roll in a rolling mill, said neck comprising:
a circular body having a tapered bore configured and dimensioned to accommodate axial mounting of said neck seal on said tapered neck section; and
axially spaced inboard and outboard flanges projecting radially outwardly from said body, said outboard flange having an outer diameter larger than the outer diameter of said inboard flange.

9. The neck seal of claim 8 wherein said inboard and outboard flanges terminate in flexible sealing lips.

10. The neck seal of claim 8 having a configuration adapted to establish a sealing relationship with an encircling seal end plate, said seal end plate having a stepped interior defining inboard and outboard sealing surfaces dimensioned for contact by the inboard and outboard flanges of said neck seal.
